(19) United States
(12) Patent Application Publication
(10) Pub. No.: US 2014/0172573 A1
(43) Pub. Date: Jun. 19, 2014

(54) SYSTEM AND METHOD FOR PLANNING AND ALLOCATING LOCATION-BASED ADVERTISING

(71) Applicant: The Rubicon Project, Inc., Los Angeles, CA (US)

(72) Inventor: Saket Saurabh, Foster City, CA (US)

(73) Assignee: The Rubicon Project, Inc., Los Angeles, CA (US)

(21) Appl. No.: 14/098,292

(22) Filed: Dec. 5, 2013

Related U.S. Application Data
(60) Provisional application No. 61/733,680, filed on Dec. 5, 2012.

(51) Int. Cl. G06Q 30/02

(52) U.S. Cl. CPC G06Q 30/0261
USPC 705/14.58

(57) ABSTRACT

A system and method for advertisers to run multiple advertisement campaigns across several locations without having to configure each campaign on a per location basis is provided. The system may determine and assign budget, target radius, duration, pricing, times of day, etc., for each ad campaign and each location. These settings are not only configured at the time of initial setup, but may also be changed dynamically to adjust for actual results and to account for time-dependent variables. In being changed dynamically, the settings may be changed periodically or aperiodically (e.g., based on events or thresholds being crossed). The setup and updates of the budget, target radius, duration pricing, times of day, etc., may be performed using an optimization algorithm, in one embodiment, based on historical information and current campaign performance, respectively.

### RELATED APPLICATIONS

This application claims priority to co-pending U.S. Provisional Patent Application Ser. No. 61/733,680 filed Dec. 5, 2012 entitled, “System And Method for Planning and Allocating Location Based Advertising,” the contents of which are hereby incorporated by reference in their entirety.

### BACKGROUND

Advertising is most effective when it is presented to a user for whom it is relevant. For a business with a physical presence, location becomes a very important criterion of relevancy as their target audience is typically formed by the people who are near a retail chain's stores or other location. The ability to reach people based on their precise location (e.g., from GPS measurements) is generally driven by two underlying trends:

(a) mobile phones with both location and data capability are becoming ubiquitous, and mobile phones have the ability to accurately detect a user's location (e.g., using GPS or triangulation) and then fetch (or be delivered) location relevant advertising (e.g., using a cellular or Wi-Fi data), and

(b) consumers have adopted and accepted location sharing as a behavior if doing so provides them with a tangible benefit without invading their privacy.

Geographic tracking of mobile telephones means a large and increasing volume of audience inventory for which users' current location is available, thus making it possible to have ads show up only in relevant, pre-determined regions (see, for example, FIG. 1).

The Challenge

When a business, such as a retailer, decides to advertise, the business typically starts with a top-level budget in mind. When the advertising strategy includes location-based advertising across hundreds of locations due to having retail stores in those locations or otherwise, the big challenge comes from the fact that each of these locations is different. With retail chain businesses, each retail store location is in a different region (e.g., different city, location within a city, at higher walking traffic areas, etc.), has different demographics (e.g., more efficient, less affluent), uses different marketing goals, potentially has a different ad campaign, etc. As the number of locations increases and other advertising parameters (e.g., different demographics, different regions, different marketing goals, etc.), setting up a location-based advertising campaign becomes complicated for advertisers, as understood in the art. For example, to allocate a budget across 100 locations with three different ad campaigns means 300 sets of optimal settings, one per-campaign per-location. Moreover, the ability to track effectiveness of an advertising campaign during the campaign for each of the locations can be very difficult. In some cases, advertising campaigns can result in hundreds or thousands of locations being established and managed for an advertising campaign, which is more than a human can manage.

### SUMMARY

The principles of the present invention provide for a system and method for advertisers to run multiple advertisement campaigns across several locations without having to configure each campaign on a per location basis. The system may determine and assign budget, target radius, duration, pricing, times of day, etc., for each ad campaign and each location. These settings are not only configured at the time of initial setup, but may also be changed dynamically to adjust for actual results and to account for time-dependent variables. In being changed dynamically, the settings may be changed periodically or aperiodically (e.g., based on events or thresholds being crossed). The setup and updates of the budget, target radius, duration pricing, times of day, etc., may be performed using an optimization algorithm, in one embodiment, based on historical information and current campaign performance, respectively.

One embodiment of a system for managing a location-based advertising campaign for advertising to mobile device users may include an input/output unit in communication with a communications network and configured to receive input parameters to establish the location-based advertising campaign, the input parameters including (i) one or more geographic locations in which the location-based advertising campaign is to be performed and (ii) a budget. A processing unit may be in communication with the input/output unit, and be configured to establish sub-geographic areas that are positioned substantially within the one or more geographic locations. Optimization model parameters that characterize the sub-geographic areas on the basis of population, demographics, and historical ad performance may be computed by the processing unit. A setup of the location-based advertising campaign may be inclusive of budget and time of advertising for the sub-geographic areas by optimizing for expected performance, where the expected performance may be estimated using the computed optimization model parameters. Overall advertising campaign parameters may be computed by aggregating the setup of the location-based advertising campaign over the sub-geographic areas. The location-based advertising campaign may be conducted based on the computed advertising campaign parameters. The optimization model parameters may be updated during the execution of the location-based advertising campaign based on performance of the location-based advertising campaign. The advertising campaign parameters may be re-computed using the optimization model parameters, and the location-based advertising using the re-computed advertising model parameters may continue to be conducted.

One embodiment of a method for managing a location-based advertising campaign for advertising to mobile device users may use a computing system and may include receiving input parameters to establish the location-based advertising campaign. The input parameters may include (i) one or more geographic locations in which the location-based advertising campaign is to be performed and (ii) a budget. Sub-geographic areas that are positioned substantially within the one or more geographic locations may be established. Optimization model parameters that characterize the sub-geographic areas on the basis of population, demographics, and historical ad performance may be computed. A setup of the location-based advertising campaign inclusive of budget and time of advertising for the sub-geographic areas by optimizing for expected performance may be computed, where the expected performance may be estimated using the computed optimization model parameters. Overall advertising campaign parameters may be computed by aggregating the setup of the location-based advertising campaign over the sub-geographic areas. The location-based advertising campaign may be conducted based on the computed advertising campaign parameters. The optimization model parameters may be updated during the execution of the location-based advertising campaign based on performance of the location-based advertising campaign. The advertising campaign parameters may be re-computed using the optimization model parameters, and the location-based advertising may continue to be conducted using the re-computed advertising model parameters.

One embodiment of a system for performing a campaign related to electronic devices may include an input/output unit configured to receive at least one campaign input parameter via a communications network, where the campaign input parameters include multiple geographic regions at which the electronic devices are located. A processing unit may be in communication with the input/output unit, and be configured to, in response to receiving campaign input parameters, set-up at least one campaign parameter for conducting the campaign. System parameters inclusive of information that affect the campaign may be determined. A set of campaign optimization equations may be established for optimizing at least one campaign parameter. The set of campaign optimization equations may be executed as a function of the campaign input parameters and system parameters to generate at least one campaign parameter. The at least one campaign parameter may be adjusted based on the optimized at least one campaign parameter. The campaign may continue to be conducted using the adjusted at least one campaign parameter.

### BRIEF DESCRIPTION OF THE DRAWINGS

Illustrative embodiments of the present invention are described in detail below with reference to the attached drawing figures, which are incorporated by reference herein and wherein:

FIG. 1 is a map of an illustrative geographic region in which a number of retail locations are shown;

FIG. 2 is an illustration of an illustrative geographic region in which sub-geographic areas have been defined;

FIG. 3 is a map of an illustrative geographic location in which geographic areas or regions that surround retail store locations of a retail chain;

FIG. 4 is an illustration of an illustrative network environment in which a location-based ad server may be configured to receive and deliver location-based ads;

FIG. 5 is an illustration of an illustrative system showing a set of ad parameters that are input by an advertiser and system parameter 504 that are established or generated by the system;

FIG. 6 is a flow diagram of an illustrative location-based advertising process for determining configuration parameters for a location-based advertising campaign;

FIG. 7 is a flow diagram of an illustrative optimization process for optimizing a location-based advertising campaign;

FIG. 8 is a flow diagram of an illustrative auction-less process for resolving ad space inventory in a competitive environment for ad space;

FIG. 9 is a flow diagram of an illustrative process for determining normalized willingness to pay (NWTP) for a given business at a specified location;

FIG. 10 is a screen shot of an illustrative user interface that enables a user, such as an advertiser or agency, to establish a number of parameters to initiate an ad campaign;

FIG. 11 is a flow diagram of an illustrative process for performing a location-based advertising campaign; and

FIG. 12 is a flow diagram of an illustrative process for conducting a campaign using electronic devices.

### DETAILED DESCRIPTION OF THE DRAWINGS

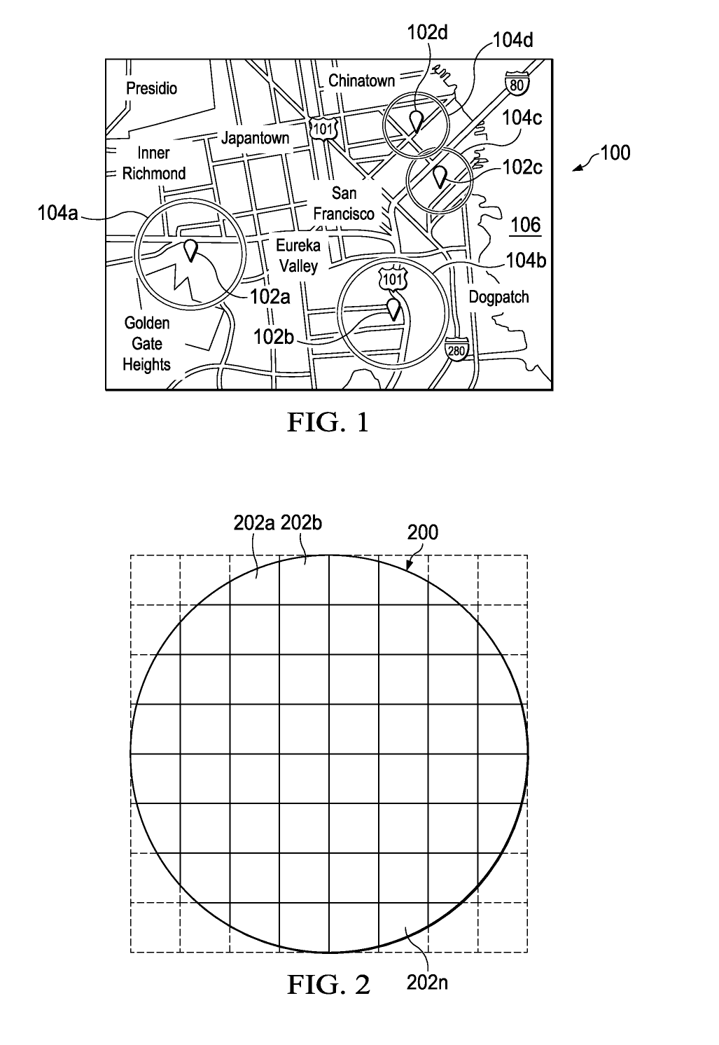

With regard to FIG. 1, a map 100 showing a number of retail locations 102a-102d (collectively 102) is shown in a geographic region, in this case San Francisco. Surrounding each of the retail locations 102a are geometric regions 104a-104d (collectively 104). Although shown as circles, the geometric regions 104 may be any other geometric or non-geometric shape. As shown, the geometric regions 104 may have different diameters as a result of a variety of different factors, including (i) population who use mobile devices or other electronic devices of which geopositioning may be determined that surround each of the retail locations 102, (ii) geographic features surrounding each of the retail locations, (iii) times of day of the established geometric regions 104, and so on. As an example, with respect to geographic features, retail location 102c is positioned close to water 106, which means that no or minimal population of potential customers is located thereat. Hence, if a geometric circle is to be used for defining a geographic region in which to communicate location-based advertisements to mobile or other electronic devices, the radius of the circle surrounding may be relatively small to avoid those unpopulated geographic features. Alternatively, larger geometric circles may be utilized with an understanding that any portions of the circle that overlay water or other uninhabited or inaccessible areas within the circle will likely be eliminated as part of an advertising target region, as further described herein. As another example, if population density is high in an urban region as compared to population density in a more rural or less populated urban region, then the geographic circles may be smaller in the more populated regions simple because higher audiences can be generated with smaller geographic areas in the high-population regions than the less-populated regions.

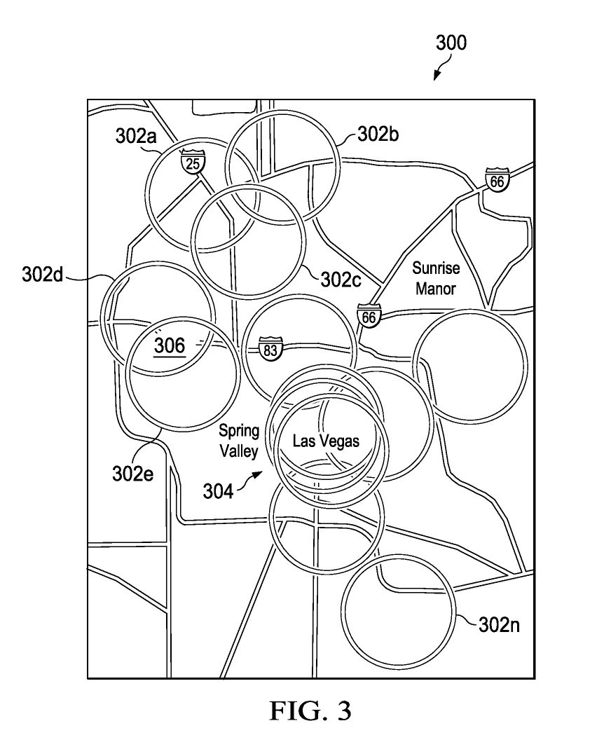

With regard to FIG. 2, an illustration of an illustrative geographic region 200 that defines an advertising area for location-based advertising that includes sub-geographic areas or tiles 202a-202n (collectively 202) is shown. The geographic region 200 is shown as a circle. However, the geographic region may be any other geometric or non-geometric shape. In one embodiment, the tiles 202 may be configured as squares. It should be understood that the tiles 202 may be configured as geometric or non-geometric shapes other than squares. In one embodiment, the tiles 202 may be configured in alignment with man-made features (e.g., roadways, malls, sporting locations, etc.), geographic features (e.g., waterways and landmasses), or otherwise. The tiles or sub-geographic areas may be used to define smaller regions within the geographic region 200 and be used by a mathematical algorithm in performing location-based advertising or other location-based function (e.g., population density tracking, transportation tracking, foot traffic surveys, city infrastructure planning or other location-based function), as further described herein.

With regard to FIG. 3, a map of an illustrative geographic location 300 in which geographic areas or regions 302a-302n (collectively 302) that surround retail store locations (not shown) of a retail chain is shown. In this embodiment, the geographic areas 302 have equal radii. However, it should be understood that the geographic areas 302 may have different radii at a starting or dynamically generated over a time period, as further described herein. As shown, geographic areas 302a, 302b, and 302c overlap with one another. In one embodiment, overlapping geographic regions provides an opportunity for the retail stores in the overlapping geographic regions to share advertising budget since at least a portion of the audience that receives advertisements in the overlapping geographic regions are considered local to multiple retail stores of the retail chain.

Overlapping geographic region 304, which includes six overlapping geographic regions associated with six respective retail stores of the same retail chain, can be shared in terms of advertising budget. In one embodiment, a calculation may be made as to how an advertising budget is shared based on overlapping geographic area. For example, a proportional sharing arrangement may be made if an amount of overlapping geographic area over a threshold value (e.g., 80%) may be made, where the proportional sharing arrangement may be split (i.e., 50% for each of the nearby retail stores) for an entire location-based advertising budget to each of the retail stores in their geographic regions. In an alternative embodiment, a percentage of overlap may define an amount of advertising budget that is to be shared between retail stores with overlapping geographic regions. As an example, for geographic regions 302d and 302e, if 40% each of the geographic regions overlap to form overlapping geographic region 306, then that 40% may be split between the retail stores (or by the retail chain itself for those retail stores) so that each of the retail stores of geographic regions 302d and 302e pay 80% of their location-based advertising (assuming consistent advertising distribution throughout the entire geographic regions 302d and 302e). If higher advertising distribution occurs within the overlapping geographic region 306 for either or both of the retail stores in the geographic regions 302d and 302e, then the location-based advertising budget may be lower for those retail stores.

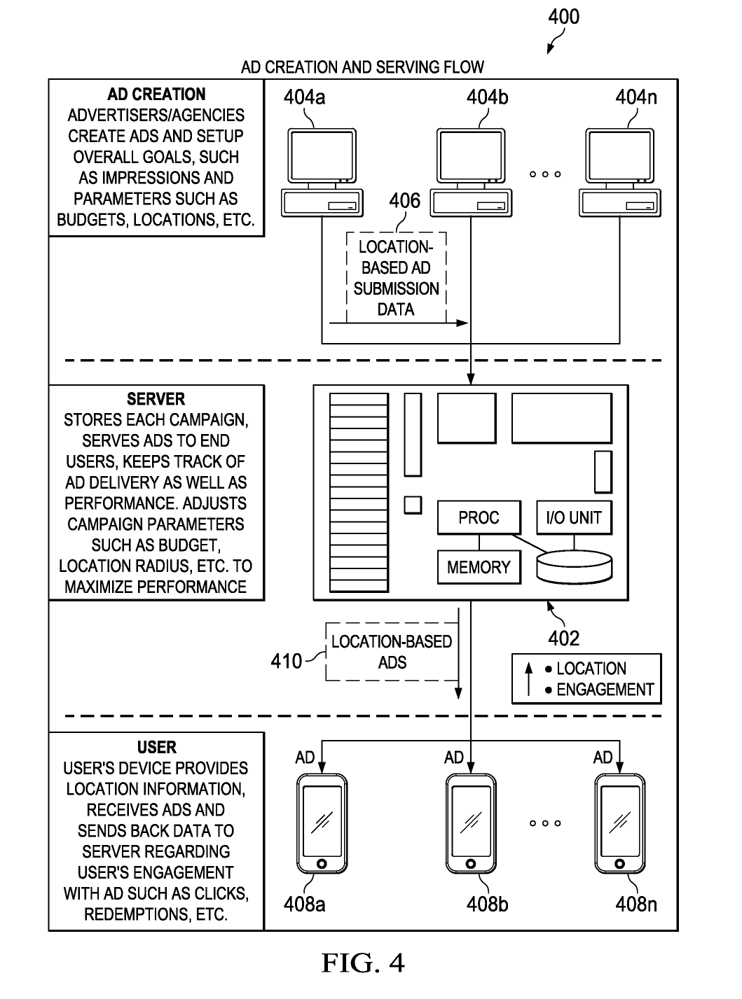

With regard to FIG. 4, an illustration of an illustrative network environment 400 in which a location-based ad server 402 may be configured to receive and deliver location-based ads is shown. The location-based ad server 402 may be configured to store location-based advertising campaigns, serve ads to end-users, manage and keep track of ad delivery and performance of ads, adjust ad campaign parameters, such as budget, location radius, etc., to maximize performance of location-based advertising for advertisers. The location-based ad server 402 may be configured with a processing unit that performs the functionality for location-based ad campaign or other location or non-location based function. The server 402 may also include a memory, input/output unit that communicates data over a communications network, such as the Internet, and storage unit that stores one or more data repository for use in storing and managing data, such as location-based ad campaign data, mapping data, user data, electronic device data, retail store data, and so forth.

Computing devices 404a-404n (collectively 404) may be utilized by advertisers or their agencies may communicate with the server 402 in order to create ads, set up overall advertising campaign goals, such as number of impressions (e.g., rating points), repeat ad impressions (e.g., gross rating points), etc., and advertisement parameters, such as budgets, geographic locations, etc. In submitting location-based advertisements, the server 402 may be configured to manage a website or other user interface that enables users of the computing devices 404 to submit location-based ad submission data 406. In an alternative embodiment, alternative location-based advertisement submissions may be made utilizing telephones, fax machines, or any other form of electronic or non-electronic communications, as understood in the art. In communicating the location-based ad submission data 406, the computing devices 404 they utilize any communications protocol over any communications network, such as the Internet or mobile communications network, as understood in the art.

Electronic devices 408a-408n (collectively 408) utilized by end-users (i.e., potential audience members) may be configured to provide location information, such as GPS location information, to the server 402. Although shown as mobile electronic devices, the electronic devices 408 may be any electronic device that is capable of being identified by geographic location. For example, if a fixed-position electronic device (e.g., desktop computer or electronic display that is remotely or locally controlled) is capable of being geographically located using automatic or manual (i.e., user entered) techniques, then the fixed-position electronic device may be included in location-based advertising campaigns. The server 402 may be configured to deliver location-based ads 410 to the electronic devices 408 that are within select geographic locations in accordance with ad campaign parameters of advertisers. As previously described, non-advertising functions, such as census, traffic, or otherwise may be performed. In one embodiment, engagement information (e.g., selection of an ad, interaction of an ad, etc.) of advertisements by the end-users may be communicated back to the server 402 by the electronic devices 408 to provide information of a users' engagement with an advertisement for storage and management thereof.

Inputs to the Location-Based Advertising System

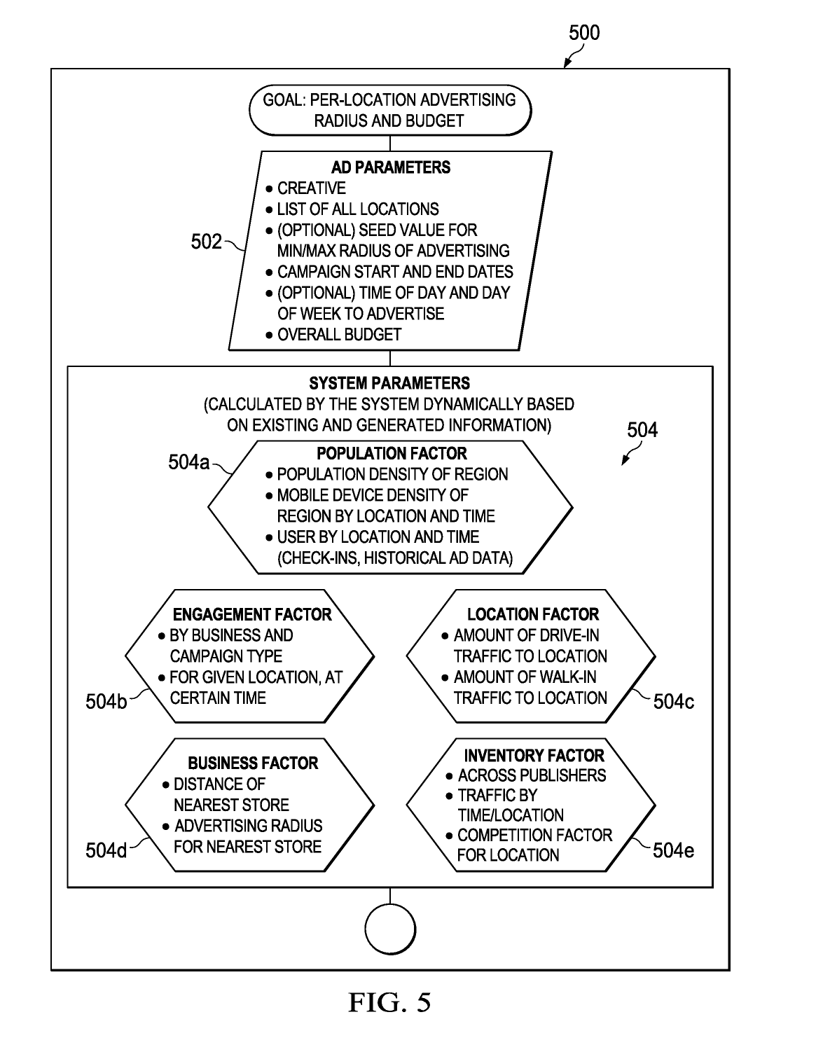

With regard to FIG. 5, an illustration of an illustrative system 500 that allows an advertiser to establish a goal using a per-location advertising radius and budget showing a set of ad parameters 502 that are input by an advertiser and system parameter 504 that are established or generated by the system 500 is shown. In conducting a location-based advertising campaign, an advertiser or its agency may provide the set of ad parameters 502 as inputs to the system 500, which may include the server 402 of FIG. 4. The system 500, in response, may generate the system parameters 504. The ad parameters 502 may include a number of different parameters, including:

(i) ad creative or content, which may include one or more images, video, text, graphics, or combination thereof for distributing to electronic devices within a location-based advertising network;

(ii) list of locations, such as retail store addresses, at or around which a location-based advertising campaign is to be executed;

(iii) optional seed value for minimum and/or maximum radius of advertising around the locations in the list of locations;

(iv) start and end dates of the location-based advertising campaign;

(v) optional time of day and day of week for the location-based advertising campaign; and

(vi) overall budget for the location-based advertising campaign.

An advertiser or its representative may utilize the following steps via a computing device, such as computing device 404a, to submit a location-based advertising campaign that may be executed by the server 402.

(i) Login to the system: Logging into the system may include the use of a username and password, as understood in the art. It should be understood that a user may alternatively utilize the system without logging into the system, but provide billing information, such as credit card information or otherwise with an advertising campaign submission.

(ii) Create a location-based advertising campaign: Creating a location-based advertising campaign may include entering the ad creative and the different ad parameters 502. Once that information is entered, the system 500 may complete the process for setting up the ad campaign by establishing system parameters and using optimization mathematics, as further described herein.

System Parameters

In generating outputs based on the ad parameters 502 submitted by the advertiser or its agency, the set of system or decision parameters 504 along with the ad parameters 502 may be utilized. Such decision parameters 504 may be used as part of an optimization process for determining and generating the outputs that are used in setting and operating a location-based advertising campaign.

The system parameters 504 may be based on a combination of external data, historical data as tracked by the system 500, and dynamic self-analysis of the location-based advertising campaign as managed by the system 500. These illustrative system parameters may be categorized as the following:

1. Population Factor 504a

As understood in the art, a high population factor indicates a greater number of potential consumers or audience members who can be reached in a unit area. The population factor may be calculated as combination of:

(a) Population density of region: The system may obtain population density information from external sources, such as census or other studies and projections, which are often categorized by population demographics.

(b) Mobile device density of region by location and time: Mobile device density of region by location and time data may be seeded or populated in the system based on data from mobile service providers, such as carriers, mobile publisher, and location based service providers.

(3) Users by location and time: User information comes from an aggregation of data from check-in services as well as historic advertising data from within the system indicating the locations and times when people used their mobile devices.

2. Engagement Factor 504b

A high engagement factor for a business type, campaign type, location, and time weighs in favor of a higher budget allocation for a location-based advertising campaign. That is, by setting or determining an engagement factor, bias towards budget allocation towards engagement factors that improve or have high-performance results for an advertiser may be generated.

By business and campaign type: The engagement factor 504b may be calculated over time by the system 500 based on observation or determination of how people engage with ads for a given category of business and type of advertisement. Engagement may be measured as clicks, signups, requests for information, actions (e.g., call to business, reservation, or coupon redemption), interactivity with advertisements, etc. Ad campaign types may vary in form, such as using coupons, promotions, brand ads, etc. Business types are categorized as type of business, such as restaurants, fashion retailers, spas, service, product sales, etc. The engagement data may be collected by time and location.

3. Customer Proximity or Location Factor 504c

A higher customer proximity factor 504c for a business means that customers are physically closer to business and, therefore, a smaller radius for delivering location-based advertising will be more effective simply because a potential customer has to travel a shorter distance to purchase goods or services from the business.

The customer proximity factor 504c may characterize the location itself to parameterize the distance that customers are willing to travel to a particular business location. For example, a quick service restaurant in a highly dense urban area may have customers travel from a couple of miles around its location, while the same business in a suburban or rural location may have customers travel from several miles away. As another example, gyms or other physical training facilities (e.g., yoga studios) tend to have a limit of a few miles from which to draw its members, which is different from a specialty automotive dealership, which may draw people from upwards of 50 miles. In one embodiment, the system 500 may have pre-established distances for business types as estimated, submitted, or computed based on submissions of other related or similar businesses in local proximity to a business conducting a location-based ad campaign.

4. Business Factor 504d

For a given store location, distance of other stores of the same business (e.g., national hamburger restaurant chain) that run the same location-based ad campaign. Advertising radius of the store in question with respect to advertising radius of its neighboring related stores, which may have the same or different advertising radius as the store in question, indicates the area overlap for a campaign. An previously described, an area overlap indicates an opportunity to share budget between retail stores at nearby locations (see, for example, FIG. 3), and may be utilized in delivering a location-based ad campaign for an advertiser.

5. Inventory Availability Factor 504e

When multiple ads run in the same geographic location either by the same advertiser or different advertisers, the ads and, consequently, advertisers compete for available audience. These ads may compete for the same spot (e.g., ad space on website, game, video, social media, emails, text messages, or otherwise) to be displayed for the same user. The ad space competition depends on two factors:

(1) Available traffic on mobile apps and websites by time and location, and

(2) Competition factor for location: a competition factor may be calculated based on how many other advertisers will be advertising in the same region at the same time.

Output by the Location-Based Advertising System

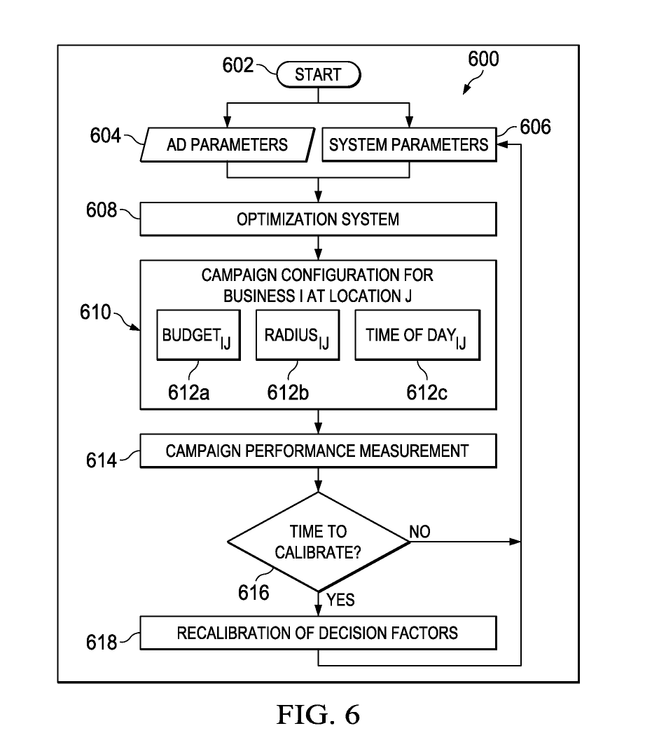

With regard to FIG. 6, a flow diagram of an illustrative location-based advertising process 600 for determining configuration parameters for a location-based advertising campaign is shown. The process 600 may start at step 602, where an advertiser or its agency may selectively initiate a location-based advertising campaign. At step 604, an advertiser or is agency may submit location-based ad parameters, as described with regard to FIG. 5. In parallel or in response to a user submitting the ad parameters at step 604, system parameters 606 may be generated and/or established (e.g., initialized).

At step 608, an optimized system 608 may be conducted. The optimization system of a location-based ad campaign may (i) be initialized or established using historical information of geographic locations at which an advertiser desires, and (ii) dynamically modify the ad campaign based on actual campaign performance.

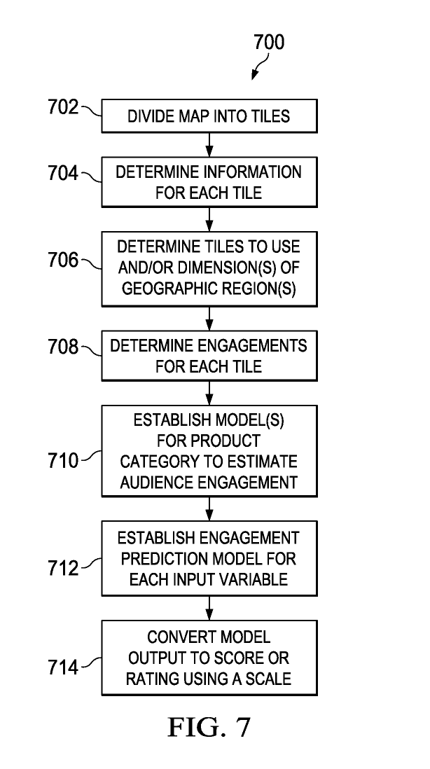

With regard to FIG. 7, a flow diagram of an illustrative optimization process 700 for optimizing a location-based advertising campaign is shown. The process 700 may start at step 702, where an entire map may be divided into tiles each of size X-by-X, where X is a physical length. Alternatively, rather than dividing an entire map into tiles, a sub-portion of a map may be divided into tiles, where the sub-portion of the map may be a predetermined area, such as surrounding a business location or any other geographic location at which an advertiser selects to advertise. Still yet, rather than dividing a map, a geographic region, such as a circle or other geometric or non-geometric area having an initially defined radius, surrounding a business location may be divided into tiles. As an example of a tile, X can be 100 meters for very fine grained optimization. Alternatively, X can be 5 miles for more coarse optimization. The value of X may be set based on a variety of factors, such as thype of geographic region (e.g., urban or rural), population density, time of day, day of week, historical factors, etc. It should be understood that rather than using square tiles, alternative geometric or non-geometric shapes may be utilized in accordance with the principles of the present invention. As an example, geometric shapes that are circular, oval, aligned with streets on a roadmap, or aligned with natural land formations (e.g., riverbank), straight and/or curved, to define borders may be utilized.

At step 704, for each tile, the following information may be determined for a time period, such as a week, either by using data sources or by using historic ad request and ad serving logs from servers:

a. Location: Latitude, Longitude boundaries for the tile

b. Tile Area

c. Population density for tile

d. Number of Mobile subscribers in tile

e. Number of Mobile ad requests from tile split by time band (i.e., number of requests in time bands T1-Tn)

f. Number of impressions served

g. Location category: Urban, Suburban, Rural

h. Age distribution by band (e.g. 18-24, 24-35, etc.)

i. Income bands (e.g. $35 k-$50 k, $50 k-$80 k, $80 k-$120 k, etc.)

j. Education average for tile (e.g. 5=Graduate, 4=College, 3=High school, etc.)

k. Number of children: Average over tile

l. Marital status: Average over tile

m. Type of media consumed (e.g., news, entertainment, sports, etc.)

n. Engagement (CTR and others) breakdown (e.g., categories 1-n at each of times T1-Tn)

o. Average Frequency (Number of exposures to a campaign)

At step 706, from the information associated with each of the tiles to be potentially used for advertising within a geographic region at a retail location, a determination of tiles to use and/or dimension(s) (e.g., radius) of geographic region(s) may be made. In one embodiment, a combination of location and radius may determine which tiles are considered or to be used. Conversely, a set of selected tiles, in turn, may indicate the map region that is to be used or, in one embodiment and more simplistically, the location and radius (when geographic regions are circular).

At step 708, ad engagements by users may be measured as an aggregate of clicks and other user actions on an ad (e.g., user touch swipes the creative, user clicks on a button, user saves the ad, etc.). In one embodiment, the engagement measurements may be historical. Alternatively, the engagement measurements by users may be measured during a location-based ad campaign.

At step 710, model(s) may be established for product categories to estimate audience engagement. For example, the product categories may be different retail stores (e.g., grocery store, clothing store, gymnasium, etc.). A discrete outcome model, as understood in the art, may be utilized, but a continuous outcome model may alternatively be utilized. At step 712, an engagement prediction model may be established for each input variable. By using an engagement prediction model, the principles of the present invention may be used to estimate engagements by users and be used to compare actual versus estimated engagements during and after an ad campaign. At step 714, the model output may be converted to a score or rating using a scale. In converting the model output to a score, the conversion may use ranges (e.g., 80-100) or other relative factors or values to generate a score, as provided hereinbelow.

Continuing with FIG. 6, the optimization system may optimize an advertising campaign utilizing the above information in conjunction with the below illustrative optimization formulas, as follows:

$${AreaLocation}_{j} = {\sum }_{Over all tiles in location j} {AreaTile}_{i}$$

A model may be created to predict engagements of viewers, where engagements may include views, clicks, emails, text messages, completing forms, purchases, interactions, etc. A number of impressions served in that location and average frequency used in the past may be utilized as input variables to the model. In one embodiment, the historical information may be stored in a data repository and accessed when populating an advertising model and optimization equation (s).

Illustrative Optimization Equations:

$$Max \sum i ∈ All locations considered \frac{\# Engagement {s}_{{L}_{i}}}{( {Budget}_{{L}_{i}} / ( C P {M}_{Li} / 1000 ) )}$$

such that Σiε All locations considered Budget Lₜ=Total Campaign Budget Where

$$E ( \# Engagement {s}_{{L}_{t}} ) = α + β ( \# impression {s}_{{L}_{t}} ) + γ ( Average {frequency}_{{L}_{t}} ) + {\sum }_{j = 1}^{j = n} {δ}_{j} ( Location {parameters}_{{L}_{tj}} ) + {\sum }_{k = 1}^{k = m} {θ}_{k} ( Demographic {parameters}_{{L}_{ik}} ) + ɛ$$

$$\# impression {s}_{{L}_{t}} = \frac{{Budget}_{{L}_{t}}}{( C P {M}_{{L}_{t}} / 1000 )}$$

$$Average {Frequency}_{Li} = \frac{\# {impressions}_{Li}}{\# Mobile {subscriber}_{Li}}$$

CPM_{Lt} may be input parameters based on an ad exchange or ad network pricing engine if the optimization model parameters are being used for an advertising campaign. Other advertising and non-advertising campaigns may use different input parameters, such as a mass transportation census tracking campaign using number of mass transportation riders, frequency of mass transportation use, distance of mass transportation rides, location of seating position on mass transportation vehicles, and so forth. Other non-advertising campaigns may include retail store tracking systems, vehicular tracking systems, and so on. These other non-advertising systems may have appropriate input parameters for optimization equations.

The initial value of optimization model parameters α, β, γ, δ, ε for each tile area may be established by predictive modeling using historical information, where both engagement value as well as value of independent variables, such as impressions, frequency, location, and demographics, are known. These model parameters are then utilized in the above illustrative optimization equations to maximize on expected performance for the campaign that is being set up. Running the optimization may result in optimal budget values (e.g., how much ad budget to spend) for each tile by time band. In one embodiment, a budget value of $0 for a particular tile eliminates the tile from location targeting consideration, thereby identifying the area(s) where an ad campaign should run (and should not run). When a restriction that a targetable collection of tiles by a circular region is enforced, the radius in which a campaign should be targeted may automatically be determined. By not enforcing this restriction, the campaign can be setup to run in an arbitrarily shaped region. It should also be understood that alternative optimization parameters may be utilized for event driven locations. For example, for locations that surround a ballpark, the principles of the present invention may include a schedule for the ballpark and change the optimization parameters around ballgames, thereby properly modeling events. It should also be understood that the principles of the present invention may provide for both scheduled and unscheduled events. As an example of an unscheduled event, optimization parameters that use historical information of natural (e.g., impending hurricane) or man-made (e.g., Superbowl victory), may be timely introduced and used by a computing system to generate and execute alternative optimization models from optimization models that would otherwise not factor in the schedule or unscheduled events. The results of the re-optimized models may be utilized in rebalancing or rescheduling ad campaigns.

Certain parameters, such as budget, target radius, duration, pricing, times of day, etc., may be automatically calculated utilizing a computing system in conjunction or as part of executing the optimization equations. Such parameters are inherently included in the optimization equations or may be integrated therein, as understood in the art.

As an example of using the optimization equation, an advertising campaign that includes San Francisco (see FIG. 1) may be created. In one embodiment, a 10 mile radius circle (or other geographic shape) may be used as a starting region that encompasses a geographic point of interest (e.g., business location). In one embodiment, 1000 tiles that define the 10 mile radius circle may be utilized. The parameters of the optimization equation may initially be populated with historical performance of similar advertising campaigns (e.g., similar business, service offerings, product offering, etc.). Periodically (e.g., weekly, daily, hourly, or otherwise) or aperiodically (e.g., number of interactions crossing a threshold, sales crossing a threshold, lack of interactions crossing a threshold, or otherwise), the parameters may be updated and the optimization equations may be recomputed. In one embodiment, optimization model parameters, such as α, β, γ, δ, ε may be altered during the ad campaign to reflect the actual advertising campaign. The optimization model parameters may be altered manually, semi-automatically, or automatically based on the advertising campaign parameters. In one embodiment, a statistical fit modeling algorithm, as understood in the art, may be utilized to identify historical ad campaign(s) that have progressed in the same or similar fashion as a current advertising campaign and change the optimization model parameters to improve the current advertising campaign based on lessons learned from the historical ad campaign(s).

As a result of the optimization equations, tiles may be determined to have a $0 budget applied thereto, which necessarily alters the geometry (e.g., radius is reduced) of the region in which the advertising campaign is being conducted. In one embodiment, the $0 budget may be determined for certain times of the day (e.g., after hours when population in a commercial region is essentially zero, tiles covering water, tile covering farmland). If tiles within an advertising region are removed, the overall shape of the advertising region may remain, but have “holes” (i.e., tiles without advertising value) within that advertising region. Similarly, the optimization system may use certain inputs to increase advertising budgets in certain tiles, such as a baseball or football schedule of a local sports team, thereby providing for improved predictive modeling, as opposed to simply using historical modeling for the advertising campaign.

With further regard to FIG. 6, at step 610, the location-based advertising system 500 may produce the following outputs:

(i) radius of advertising for each geographic location,

(ii) advertising budget for each geographic location,

(iii) times of day for advertising,

(iv) dynamic calibration of (i), (ii), and (iii) during the advertising campaign.

As shown, the budget 612a, radius 612b, and time of day 612c outputs (collectively 612) may be computed by computing each I and J combinational values of the respective outputs as a function of the ad parameters 604 and system parameters 606. In computing each of the I and J combinational values of the respective outputs 612, where I may be a business entity of multiple business entities and J may be a tile of multiple times within a particular geographic area, linear algebra or conventional looping may be utilized by a computing system, such as server 402, in accordance with the principles of the present invention. The step 610 may be included as part of the optimization system 608 or be independent, as shown.

At step 614, the process 600 may measure campaign performance. In measuring campaign performance, a variety of measurements may be collected, including number of impressions, number of electronic devices (mobile or otherwise) located in geographic regions of interest, demographics of users, number of user engagements, and so forth over times of day so as to more precisely track tiles within regions to generate more accurate predictions and ad campaign budgeting during an existing and for future ad campaigns.

At step 616, a determination as to whether to calibrate the decision factors may be made. The determination may be performed on a periodic or aperiodic basis. If on a periodic basis, the system may make a determination once a week, once a day, once an hour, or other periodic basis. If on an aperiodic basis, the determination may be made in response to a system parameter crossing a threshold (e.g., number of engagements being higher or lower than a high or low engagement threshold, number of impressions being higher or lower than a high or low impressions threshold, etc.), change in an ad parameter of an ad campaign (e.g., budget being changed, audience size target being adjusted, demographics being changed, etc.), or any other event or non-event parameter being satisfied. If the determination is yes, then at step 618, one or more decision factors (e.g., population factor 504a, engagement factor 504b, customer proximity or location factor 504c, business factor 504d, and inventory availability factor 504e) may be recalibrated. In recalibrating any of these factors, feedback as a result of the campaign performance measurement at step 614 may be utilized to recalibrate. In one embodiment, the recalibration may be estimated based on a model. Alternatively, actual (i.e., raw data), averaged, or other mathematically computed measurements may be utilized. The recalibration may be made during time intervals (e.g., during business hours, rush hour traffic) or event driven intervals (e.g., during a sporting event, parade, etc.), as previously described. If the determination at step 616 is negative, then the process 600 may return to step 606 or 608 to continue executing the location-based ad campaign.

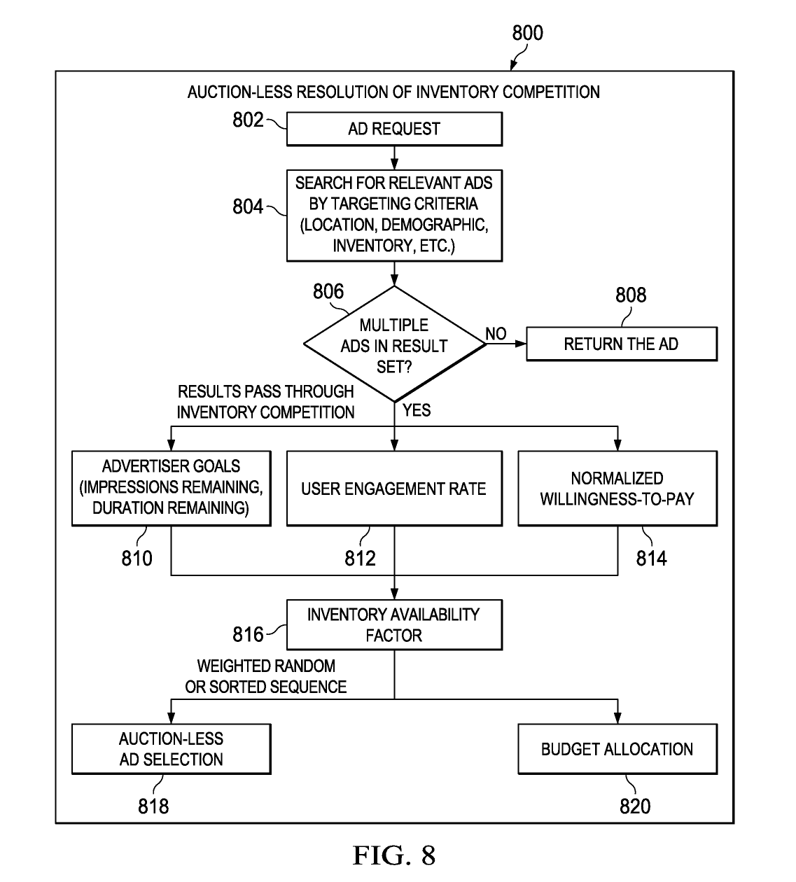

With regard to FIG. 8, a flow diagram of an illustrative auction-less process for resolving ad space inventory in a competitive environment for ad space is shown. The process may start at step 802, where an ad request may be received. The ad request may be a location-based ad request by a user of an electronic device, such as a smart telephone. The location-based ad request may be made as a result of requesting a view that includes the ad space for an advertisement, such as a website on a mobile browser, game with ad space, or any other view or app that includes ad space. At step 804, a search for relevant ads by targeting criteria may be performed. The criteria may include location, demographics, inventory, etc. of which each respective ad campaign advertiser includes as input parameters, as previously described.

At step 806, a determination may be made by a server or other computing system as to whether multiple ads are available in a result set from the search for ads to fill the ad space of step 804. If not, then the system may return an ad identified from the search at step 808 for display on an electronic device of the user. Alternatively, the multiple results of the search at step 804 may pass through inventory competition, which may include (i) advertiser goals at step 810, (ii) user engagement rate at step 812, and (iii) normalized willingness-to-pay (NWTP) at step 814. As shown, steps 810-814 may be performed in parallel. Alternatively the steps 810-814 may be performed in series.

It is common to use an auction-based system to resolve such competition for inventory. However, running a pure auction makes ad advertising campaign more complicated for the advertiser, as the advertiser needs to know that a bid will be high enough to attract traffic while wanting to have a control on the budget that the advertiser spends. With multiple locations, where each location may have a different inventory characteristic, means that for an auction system, the relevant bid range is generally different for each location.

Unlike auction on keywords where similar businesses compete for a given keyword, the businesses competing for location-based inventory can be of varying sizes and types. The location-based inventory competition means that, in an auction based system, a small bakery may get consistently out-competed by a neighboring large retailer, for example. Therefore, in one embodiment, the system may resolve competition among competing advertisers bidding for ad space by not using a pure price-based auction for resolving inventory competition. Hence, to simplify the location-based ad campaigns for advertisers, the location-based ad campaign system may use a combination of the following factors in addition to pricing to resolve ad space competition on electronic devices in geographic regions:

User engagement comparison of competing ads: User engagement comparison of competing ads takes a consumer perspective on ad selection, where ads that receive greater user engagement are considered more relevant for the user and, hence, receive a greater weighting. The user engagement in some cases may be more meaningful than simply knowing demographics in a desired geographic area because user engagement reflects actual advertisement “pull” of an audience, which is generally more meaningful for an advertiser than impressions of an audience, even a well-matched demographic audience.

Advertiser Goals: Different ads typically run with different ad delivery goals. In one embodiment, the advertiser goals may include number of impressions and a timeframe during which an ad is to run. In attempting to achieve the advertiser goals, the location-based advertising system may track (i) impressions delivered and remaining and (ii) duration elapsed and remaining during the ad campaign. For example, there may be an ad with 3 days to go and only 10 impressions to be served. Such an ad is likely to run out earlier than its campaign duration. On the other hand, a competing ad may have only 1 day remaining but 10,000 impressions to serve. When comparing these two ads, the system may consider these goals and alter the weighting in a way to optimize completion of goals for each of the ad campaigns. A similar weighting may be performed for multiple goals in a formulaic manner. Other advertiser goals may be included as part of a location-based ad campaign and be compared amongst competing ads in overlapping locations and times.

Advertiser's Normalized Willingness-to-Pay (NWTP): Unlike conventional willingness-to-pay (WTP), which assigns a dollar amount to a specific outcome, the NWTP for a given location is a percentile across all locations of a given business. NWTP is directly related to the product of engagement rate for a location and the average ticket price for the location. If average ticket price is unknown, the average ticket price is equated to 1. If a business has no historic data for engagement at a given location, then the business inherits the location's average engagement rate.

At step 816, an inventory availability factor or weighting may be generated based on the advertiser goals. That is, the system may balance these three factors and/or other factors along with price to resolve competition among location-based ad campaigns. More specifically, each ad campaign may receive an inventory availability weighting based on these criteria. This weighting may be used to perform a weighted random or other selection algorithm among the competing location-based ad campaigns. The use of a weighted random selection mechanism ensures that the final decision is not purely deterministic, but rather adjusts the inclination of the location-based advertising system. It is certainly possible to make the system purely deterministic by rank ordering the campaigns by their weights. Alternative non-deterministic or deterministic processes may be utilized in accordance with the principles of the present invention.

At step 818, a weighted random or sorted sequence of ads may be communicated to or accessed by an auction-less ad selection process. Alternatively, the inventory availability weightings associated with different available ads may be used during an auction-less ad selection process. At step 820, which may be performed in parallel or series with step 818, may allocate budget for each of the ad campaigns. In allocating budgets, the system may use a variety of different factors to manage an ad campaign budget, including geographic locations, budget spend rate, and other factors that may be used in managing an ad campaign. It should be understood that the process 800 may be used for each geographic location in which location-based ad campaigns are being executed and compete for limited ad space.

These goals and factors may also be used at the time of setting up a new campaign, as an input for calculating budget allocation to a given location. When starting a new campaign, historical data may be used for these factors for the advertiser in consideration. If such historical data is not available for the advertiser, then the average value for other advertisers at the target location may be used. The new advertiser for the location thus starts at an overall neutral position. If the target location has absolutely no historical data for any advertiser, then a baseline (e.g., middle of the scale) value may be utilized in accordance with the principles of the present invention. As an ad campaign is being conducted and historical data is generated, the factors, such as inventory availability factor 504e, may be accordingly adjusted.

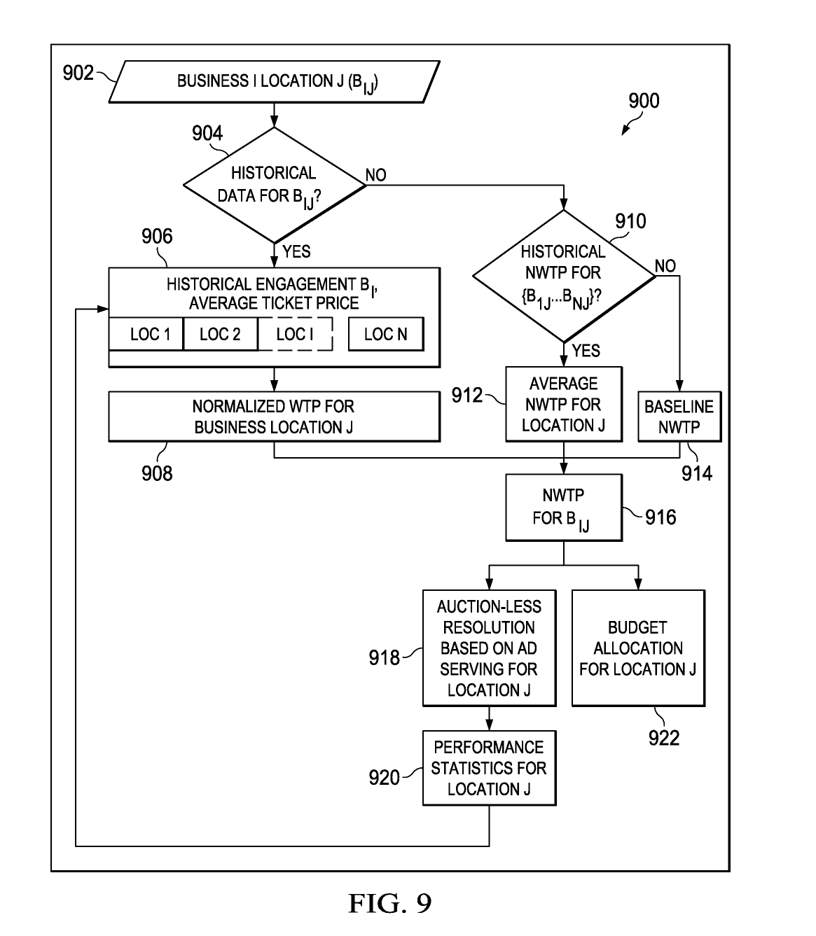

With regard to FIG. 9, a flow diagram of an illustrative process 900 for determining normalized willingness to pay (NWTP) for a given business at a specified location is shown. The process 900 may start at step 902, where a business I at location J (B_{IJ}) may be selected. At step 904, a determination is made as to whether historical data for business B_{IJ} is made. If historical data is available for business B_{IJ}, then the process 900 continues at step 906, where historical engagement of businesses B_{IJ} and average ticket price may be determined for each location (e.g., tiles). At step 908, a normalized WTP for business location J may be computed.

If at step 904 the result is that no historical data is available, the process 900 continues at step 910, where a determination is made as to whether historical NWTP for each of the businesses I are generated within each of the locations J (i.e., B_{IJ}) exists. If so, then the process continues at step 912 to compute an average NWTP for location J. Alternatively, the process continues at step 914 to compute a baseline NWTP.

At step 916, NWTP is computed for each of the businesses I in each of the locations J. At step 918, an auction-less resolution based ad serving may be made for location J. That is, ad distribution for an ad within a location J may be made based on a number of parameters or factors, as previously described. At step 920, performance statistics for location J may be determined and updated. The process returns back to step 906 thereafter. In one embodiment, step 922 for budgeting allocation for location J may be determined in parallel with step 918. The budgeting allocation may alternatively be computed in series (i.e., prior to or after) with step 918.

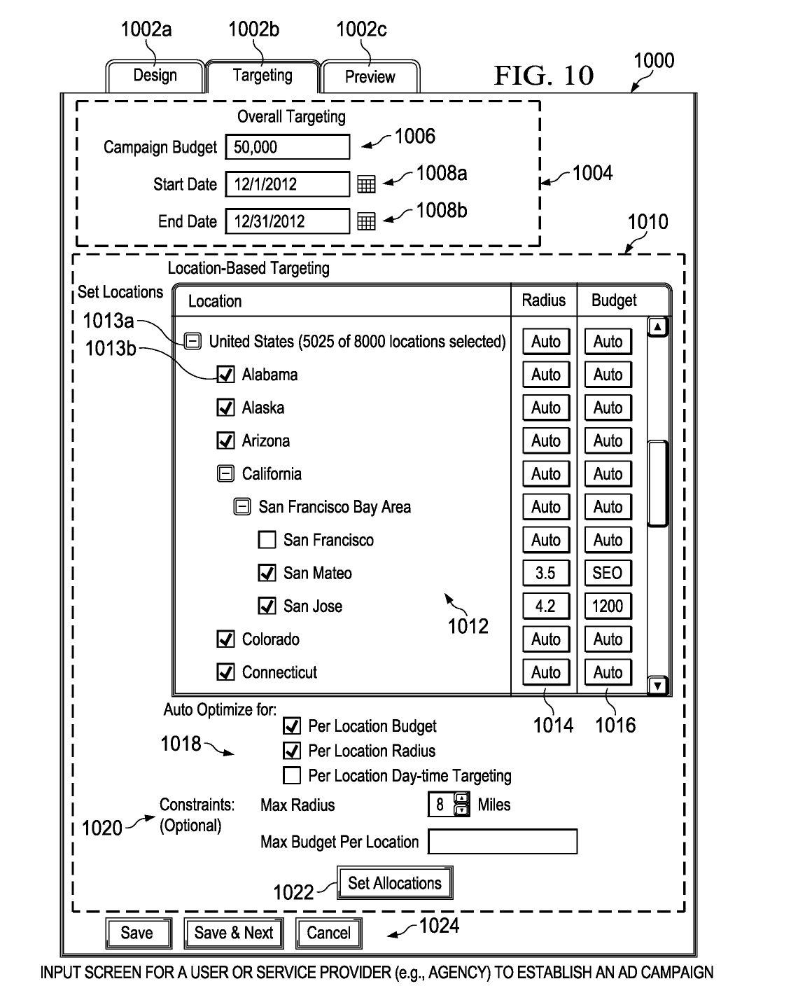

With regard to FIG. 10, a screen shot of an illustrative user interface 1000 that enables a user, such as an advertiser or agency, to establish a number of parameters to initiate an ad campaign is shown. The user interface 1000 includes three tabs, including a “design” tab 1002a, “targeting” tab 1002b, and “preview” tab 1002c. It should be understood that additional and/or alternative tabs may be utilized for supporting location-based ad campaigns in accordance with the principles of the present invention.

The “design” tab 1002a may be a page that allows a user (e.g., advertiser or its agency) to create an advertisement that creates a location-based ad inclusive of content, text, graphics, animation, etc. that complies with ad space parameters (e.g., mobile phone, tablet, etc. format and technology configurations).

The “targeting” tab 1002b includes a location-based ad campaign submission form 1010 with information for submitting location-based targeting of an ad that is created by the user. As shown, the form may include a listing of geographic locations organized in a hierarchical manner, such as country, state, region, city, etc. It should be understood that zip codes or other geopolitical identifiers may be utilized, as well. Expansion elements 1013a and selection elements 1013b may be associated with each of the geographic location listings 1012 to allow the user to “drill down” to view and select specific geographic locations in which the user desires to advertise. Assuming that the system is configured to use circles, a radius distance selection element 1014 associated with each geographic region may be entered (e.g., text entry field), selected (e.g., drop-down list of distances), or set for “auto,” which causes the system to automatically set a radius for each respective geographic location. If non-circular geographic regions are used to define a location-based region by the location-based ad system, then other dimensions and configurations may be utilized.

A budget selection element 1016 associated with each respective geographic region may allow the user to enter a budget for each of the geographic regions. Alternatively, the user may select an “auto” selection to cause the system to automatically allocate a budget for each of the geographic regions. In one embodiment, the auto selection may cause the system to even split the budget in each of the selected geographic regions. Alternatively, the auto selection may cause the system to weight the budget toward the highest-value geographic regions (e.g., regions in which a higher density of desired audience is located based on matching demographics of known audience members). In one embodiment, the system may auto-populate the radius 1014 and budget 1016 selection elements with actual values that are computed after an ad campaign begins. These auto-populated fields may thereafter be non-adjustable by the user or be adjustable by the user to affect future allocations.

The submission form 1010 may also include selectable auto optimization parameters 1018 that allow the user to select whether or not to automatically optimize a (i) per location budget parameter, (ii) per location radius parameter, and (iii) per location day-time targeting parameter for each geographic location (e.g., retail location). Alternatively, if the optimization parameters 1018 are not selected, then the user may manually set and update the parameters. The updating of the optimization parameters may be periodic or aperiodic, as previously described. Constraints, such as maximum and/or minimum radius, budget per location, or otherwise may be set, as well.

The submission form 1010 may also include constraints for maximum radius (e.g., 8 miles), maximum budget per location (e.g., $3,000 for Las Vegas), and any other constraints as established by the ad network and/or advertiser. Once the user has completed entering the location-based ad information into the submission form 1010, the user may select a “set allocations” soft-button 1022 to cause the entries to be set for the ad campaign. Soft-buttons 1022, which may include a “save” soft-button 1022a, “save & next” soft-button 1022b, and “cancel” soft-button 1022c may be available for the user to save, save and submit information for another ad campaign, or cancel the ad submission request.

The “preview” tab 1002c may allow a user to preview how a location based ad is to appear on one or more electronic devices (e.g., smartphone, tablet, devices with different operating systems, etc.) and potentially a map of a geographic region optionally showing tiles with estimates within the geographic area and/or tiles of impressions over one or more time periods. In one embodiment, a time-sequence (e.g., simulation) showing impression, interactions, engagements, or other estimates, either using a mathematical model or historical data, may be presented to the user to allow the user to adjust a location-based ad campaign prior to initiating. The time-sequence may also be filtered based on demographics, geographics, combinations, or otherwise. The time-sequence concept may also operate as a “replay” of an actual ongoing or previous location-based ad campaign to show a user how the existing or previous location-based ad campaign actually performed. Still yet, a comparison between predicted and actual location-based ad campaign may be generated and presented to a user, thereby allowing the user to better tailor a location-based ad campaign in the future. In addition to the user better tailoring future location-based ad campaigns, the system may use such historical comparisons as feedback for ongoing and future location-based ad campaigns using optimization or other mathematical equations.

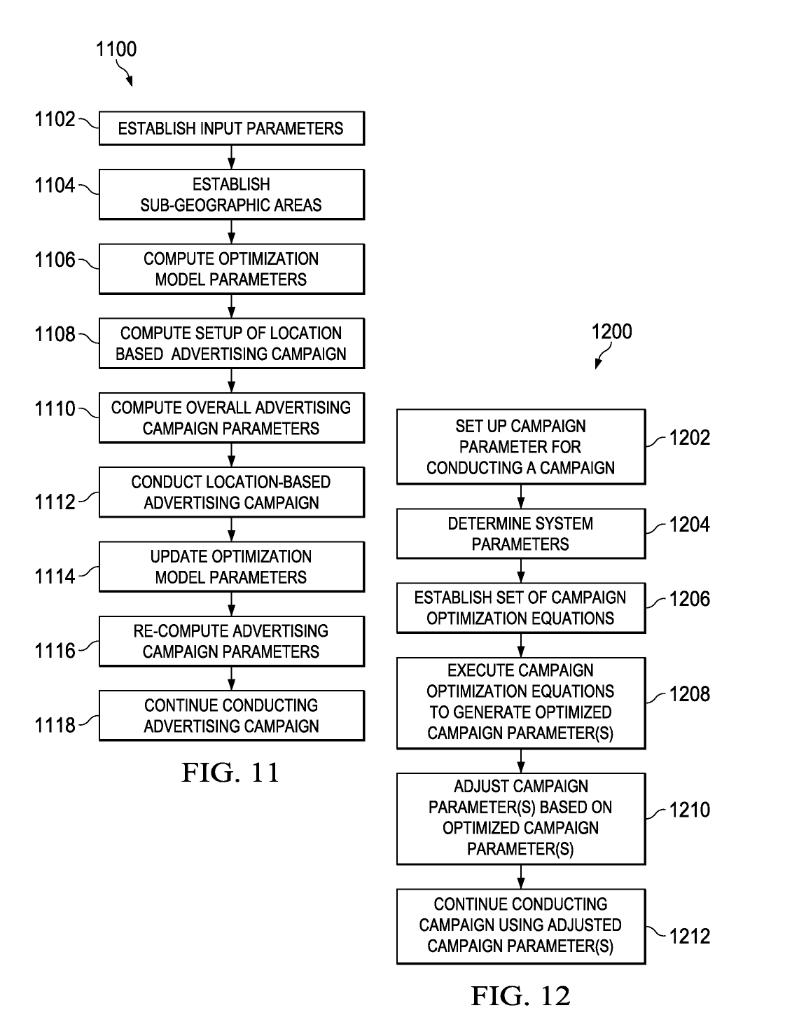

With regard to FIG. 11, a flow diagram of an illustrative process 1100 for conducting a location-based advertising campaign is shown. The location-based advertising campaign may include communicating advertisements to mobile device or non-mobile device users within geographic areas. The process 1100 may start at step 1102, where input parameters may be received to establish the location-based advertising campaign. The input parameters may be received from an advertiser or its agency and include (i) one or more geographic locations in which the location-based advertising campaign is to be performed and (ii) a budget. At step 1104, sub-geographic areas that are positioned substantially within the one or more geographic locations may be established. At step 1106, optimization model parameters that characterize the sub-geographic areas on the basis of population, demographics, and historical ad performance may be computed. At step 1108, a setup of the location-based advertising campaign inclusive of budget and time of advertising for the sub-geographic areas by optimizing for expected performance may be computed, where the expected performance may be estimated using the computed optimization model parameters.

Overall advertising campaign parameters may be computed by aggregating the setup of the location-based advertising campaign over the sub-geographic areas at step 1110. At step 1112, the location-based advertising campaign may be conducted based on the computed advertising campaign parameters. At 1114, the optimization model parameters may be updated during the execution of the location-based advertising campaign based on performance of the location-based advertising campaign. At step 1116, the advertising campaign parameters may be re-computed using the optimization model parameters, and the location-based advertising may continue to be conducted using the re-computed advertising model parameters at step 1118. It should be understood that the process 1100 may be utilized for non-location-based advertising campaigns or non-advertising campaigns altogether. In the event of using the process 1100 for such non-location-based advertising campaigns, the optimization variables would be modified to match the advertising or non-advertising operations that are being performed, as previously described herein.

With regard to FIG. 12, a flow diagram of an illustrative process 1200 for conducting a campaign related to electronic devices is shown. The process 1200 may include setting up at least one campaign parameter for conducting the campaign in response to receiving campaign input parameters. The campaign input parameters may include multiple geographic regions at which the electronic devices are located. At step 1204, system parameters inclusive of information that affect the campaign may be determined. A set of campaign optimization equations may be established for optimizing at least one campaign parameter at step 1206. At step 1208, the set of campaign optimization equations may be executed as a function of the campaign input parameters and system parameters to generate at least one campaign parameter. In executing the optimization equations, a processing unit operating on a computing system may calculate the at least one campaign parameter. At step 1210, the campaign parameter(s) may be adjusted based on the optimized at least one campaign parameter. The campaign may continue to be conducted using the adjusted at least one campaign parameter at step 1212.

At least one campaign parameter may include a budget for conducting the campaign, where the budget may be an overall budget for the campaign. The information of the system parameters may include historical information of the system parameters in association with the geographic locations. The historical information may include historical information of a number of electronic devices located within the geographic regions during particular time periods. Existence of electronic devices within the geographic locations may be identified in performing the campaign. A determination of traffic flow of a transportation system may be determined using the existence of the electronic devices. In adjusting the campaign parameter(s), size of the geographic regions may be dynamically adjusted during the campaign. A determination as to whether two geographic regions overlap may be made, and, in response to determining whether two geographic regions overlap, an amount of overlap of the two geographic regions may be computed, thereby enabling an amount of financial sharing for the overlapping two regions to be computed.

Additionally, multiple tiles within each of the geographic regions may be generated, and the set of campaign optimization equations may be executed as a function of the campaign input parameters and at least one system parameter over the tiles to generate the campaign parameter(s). At least one campaign parameter may be a radius of a circle that defines each of the respective geographic regions.

The previous description is of a preferred embodiment for implementing the invention, and the scope of the invention should not necessarily be limited by this description. The scope of the present invention is instead defined by the following claims.

What is claimed is:

1. A system for managing a location-based advertising campaign for advertising to mobile device users, said system comprising:
an input/output unit in communication with a communications network and configured to receive input parameters to establish the location-based advertising campaign, the input parameters including (i) one or more geographic locations in which the location-based advertising campaign is to be performed and (ii) a budget;
a processing unit in communication with said input/output unit, and configured to:
establish sub-geographic areas that are positioned substantially within the one or more geographic locations;
compute optimization model parameters that characterize the sub-geographic areas on the basis of population, demographics, and historical ad performance;
compute a setup of the location-based advertising campaign inclusive of budget and time of advertising for the sub-geographic areas by optimizing for expected performance, the expected performance being estimated using the computed optimization model parameters;
compute overall advertising campaign parameters by aggregating the setup of the location-based advertising campaign over the sub-geographic areas;
conduct the location-based advertising campaign based on the computed advertising campaign parameters;
update the optimization model parameters during the execution of the location-based advertising campaign based on performance of the location-based advertising campaign;
re-compute the advertising campaign parameters using the optimization model parameters; and
continue conduct the location-based advertising using the re-computed advertising model parameters.

2. The system according to claim 1, wherein said processing unit, in computing the optimization model parameters, is further configured to compute campaign budget, start date, and maximum radius.

3. The system according to claim 1, wherein said processing unit, in computing the optimization model parameters, is configured to identify one or more advertising parameters to be optimized.

4. The system according to claim 3, wherein said processing unit, in computing the one or more advertising parameters, is configured to compute budget, radius, and time-of-day targeting.

5. The system according to claim 4, wherein said processing unit, in computing the budget, is configured to compute the budget for a sub-geographic area within a geographic area.

6. The system according to claim 5, wherein, in response to computing a budget of zero dollars within a sub-geographic area, removing the sub-geographic area from consideration for an advertising campaign.

7. The system according to claim 1, wherein updating the optimization model parameters includes periodically updating the optimization model parameters.

8. The system according to claim 1, wherein updating the optimization model parameters includes updating number of impressions, average frequency, and location parameters.

9. The system according to claim 1, wherein establishing optimization model parameters includes setting optimization model parameters based on historical information of other location-based advertising campaigns being performed in the geographic locations.

10. A method for managing a location-based advertising campaign for advertising to mobile device users, said method comprising:
receiving, by a computing system, input parameters to establish the location-based advertising campaign, the input parameters including one or more geographic locations in which the location-based advertising campaign is to include and a budget;
establishing, by the computing system, sub-geographic areas that are positioned substantially within the one or more geographic locations;
computing, by the computing system, optimization model parameters that characterize the sub-geographic areas on the basis of population, demographics, and historical ad performance;
computing, by the computing system, a setup of the location-based advertising campaign inclusive of budget and time of advertising for the sub-geographic areas by optimizing for expected performance, the expected performance being estimated using the computed optimization model parameters;
computing, by the computing system, overall advertising campaign parameters by aggregating the setup of the location-based advertising campaign over the sub-geographic areas;
conducting, by the computing system, the location-based advertising campaign based on the computed advertising campaign parameters;
updating, by the computing system, the optimization model parameters during the execution of the location-based advertising campaign based on performance of the location-based advertising campaign;
re-computing, by the computing system, the advertising campaign parameters using the optimization model parameters; and
continue conducting, by the computing system, the location-based advertising using the re-computed advertising model parameters.

11. The method according to claim 10, wherein computing the optimization model parameters includes computing campaign budget, start date, and maximum radius.

12. The method according to claim 10, wherein computing the optimization model parameters includes identifying one or more advertising parameters to be optimized.

13. The method according to claim 12, wherein computing the one or more advertising parameters includes computing budget, radius, and time-of-day targeting.

14. The method according to claim 13, wherein computing the budget includes computing the budget for a sub-geographic area within a geographic area.

15. The method according to claim 14, wherein, in response to computing a budget of zero dollars within a sub-geographic area, removing the sub-geographic area from consideration for an advertising campaign.

16. The method according to claim 10, wherein updating the optimization model parameters includes periodically updating the optimization model parameters.

17. The method according to claim 10, wherein updating the optimization model parameters includes updating number of impressions, average frequency, and location parameters.

18. The method according to claim 10, wherein establishing optimization model parameters includes setting optimization model parameters based on historical information of other location-based advertising campaigns being performed in the geographic locations.

19. A system for performing a campaign related to electronic devices, said system comprising:
an input/output unit configured to receive at least one campaign input parameter via a communications network, the campaign input parameters including a plurality geographic regions at which the electronic devices are located; and
a processing unit in communication with said input/output unit, and configured to:
in response to receiving campaign input parameters, set-up at least one campaign parameter for conducting the campaign;
determine system parameters inclusive of information that affect the campaign;
establish a set of campaign optimization equations for optimizing at least one campaign parameter;
execute the set of campaign optimization equations as a function of the campaign input parameters and system parameters to generate at least one campaign parameter;
adjust the at least one campaign parameter based on the optimized at least one campaign parameter; and
continue to conduct the campaign using the adjusted at least one campaign parameter.

20. The system according to claim 19, wherein the at least one campaign parameter further includes a budget for conducting the campaign.

21. The system according to claim 19, wherein the information of the system parameters includes historical information of the system parameters in association with the geographic locations.

22. The system according to claim 21, wherein the historical information includes historical information of a number of electronic devices located within the geographic regions during particular time periods.

23. The system according to claim 19, wherein said processing unit is further configured to identify existence of electronic devices within the geographic locations in performing the campaign.

24. The system according to claim 23, wherein said processing unit is further configured to determine traffic flow of a transportation system.

25. The system according to claim 19, wherein said processing unit, in adjusting the at least one campaign parameter, is configured to dynamically adjust size of the geographic regions during the campaign.

26. The system according to claim 25, wherein said processing unit is further configured to:
determine whether two geographic regions overlap;
in response to determining whether two geographic regions overlap, compute an amount of overlap of the two geographic regions; and
compute an amount of financial sharing for the overlapping two regions.

27. The system according to claim 19, wherein said processing unit is further configured to:
generate a plurality of tiles within each of the geographic regions; and
execute the set of campaign optimization equations as a function of the campaign input parameters and at least one system parameter over the plurality of tiles to generate the at least one campaign parameter.

28. The system according to claim 27, wherein the at least one campaign parameter is a radius of a circle that defines each of the respective geographic regions.
